(19) United States
(12) Patent Application Publication
(10) Pub. No.: US 2025/0103041 A1
(43) Pub. Date: Mar. 27, 2025

(54) ASSESSING SCHEDULE DISRUPTION RISK IN AN AUTOMATED INDUSTRIAL MAINTENANCE PROCESS

(71) Applicant: Mobideo Technologies Ltd., Rosh Haayin (IL)

(72) Inventors: Amir GREEN, Moshav-Herut (IL); Moshe TANNENBAUM, Jerusalem (IL)

(73) Assignee: Mobideo Technologies Ltd., Rosh Haayin (IL)

(21) Appl. No.: 18/729,533

(22) PCT Filed: Jan. 18, 2023
(86) PCT No.: PCT/IL2023/050051

§ 371 Date: Jul. 17, 2024

Related U.S. Application Data
(60) Provisional application No. 63/300,283, filed on Jan. 18, 2022.

(51) Int. Cl. G05B 23/02

(52) U.S. Cl. CPC G05B 23/0283

(57) ABSTRACT

There is provided a system of assessing risk of schedule disruption in executing an automated maintenance process plan in an industrial facility, the maintenance process plan comprising sequences of maintenance tasks, the system comprising: a first processing circuitry configured to, repeatedly: receive, from monitoring units (MUs), data indicative of progress of a maintenance task of a sequence, and determine, in accordance with the received task progress data, data indicative of an updated scheduled start time of a subsequent maintenance task of the sequence, thereby giving rise to an updated total float value (TFV) of the sequence; and a second processing circuitry configured to, repeatedly: store data indicative of an updated TFV of the maintenance task sequence; calculate a degree of schedule disruption risk from the updated TFV history, and responsive to the calculated degree of schedule disruption risk meeting a threshold: raise an alert, or revise the maintenance process plan.

### TECHNICAL FIELD

The presently disclosed subject matter relates to industrial control systems, and in particular to automated control of maintenance procedures in such systems.

### BACKGROUND

Problems of implementation in systems for automation of control of industrial maintenance have been recognized in the conventional art and various techniques have been developed to provide solutions.

### GENERAL DESCRIPTION

According to one aspect of the presently disclosed subject matter there is provided a system of assessing a degree of risk of schedule disruption in executing a automated maintenance process plan in an industrial facility, the automated maintenance process plan comprising a plurality of sequences of maintenance tasks, the system comprising:
a) a first processing circuitry configured to, repeatedly:
   i) receive, from one or more monitoring units (MUs), data indicative of progress of a maintenance task of a first maintenance task sequence of the plurality of sequences of maintenance tasks, and
   ii) determine, in accordance with the received task progress data, data indicative of an updated scheduled start time of a subsequent maintenance task of the first maintenance task sequence,
      thereby giving rise to an updated total float value (TFV) of the first maintenance task sequence;
b) a second processing circuitry configured to, repeatedly:
   i) obtain and store data indicative of an updated TFV of the first maintenance task sequence, thereby giving rise to an updated TFV history of the first maintenance task sequence,
   ii) calculate, for the first maintenance task sequence, a degree of schedule disruption risk, in accordance with, at least, the updated TFV history of the first maintenance task sequence, and
   iii) responsive to, at least, the calculated degree of schedule disruption risk meeting a threshold, perform at least one action from a group consisting of:
      a. raising an alert, and
      b. revising the maintenance process plan.
         In addition to the above features, the system according to this aspect of the presently disclosed subject matter can comprise one or more of features (i) to (x) listed below, in any desired combination or permutation which is technically possible:
i. the second processing circuitry is configured to calculate the degree of schedule disruption risk in accordance with a metric of current TFV decrease
ii. the second processing circuitry is configured to calculate the degree of schedule disruption risk in accordance with a difference between an initial TFV and a current TFV
iii. the initial TFV is a TFV indicated by the maintenance process plan, and the current TFV is a most recently received TFV
iv. the threshold is in accordance with a difference between a scheduled current TFV and the initial TFV, wherein the scheduled current TFV is a TFV indicated by the maintenance project plan for a time corresponding to the current TFV
v. the second processing circuitry is configured to calculate the degree of schedule disruption risk in accordance with a machine learning model classification of data that is in accordance with at least 2 TFVs of the updated TFV history of the first task sequence
vi. the second processing circuitry is further configured to calculate the degree of schedule disruption risk in accordance with a machine learning model classification of data that is in accordance with additional data associated with the first task sequence
vii. the second processing circuitry is configured to perform the at least one action additionally responsive to, at least, a criticality of equipment maintained in the first maintenance task sequence
viii. the second processing circuitry is configured to perform the at least one action additionally responsive to, at least, an operational importance of the maintenance tasks of the first maintenance task sequence
ix. the second processing circuitry is configured to perform the at least one action additionally responsive to, at least, a duration of the first maintenance task sequence
x. the first processing circuitry and the second processing circuitry are integrated
   According to another aspect of the presently disclosed subject matter there is provided a method of assessing a degree of risk of schedule disruption in executing a automated maintenance process plan in an industrial facility, the automated maintenance process plan comprising a plurality of sequences of maintenance tasks, the method comprising:
a) performing, repeatedly, by a first processing circuitry:
   i) receiving, from one or more monitoring units (MUs), data indicative of progress of a maintenance task of a first maintenance task sequence of the plurality of sequences of maintenance tasks, and
   ii) determining, in accordance with the received task progress data, data indicative of an updated scheduled start time of a subsequent maintenance task of the first maintenance task sequence,
      thereby giving rise to an updated total float value (TFV) of the first maintenance task sequence;
b) performing, repeatedly, by a second processing circuitry:
   i) obtaining and storing data indicative of an updated TFV of the first maintenance task sequence, thereby giving rise to an updated TFV history of the first maintenance task sequence,
   ii) calculating, for the first maintenance task sequence, a degree of schedule disruption risk, in accordance with, at least, the updated TFV history of the first maintenance task sequence, and
   iii) responsive to, at least, the calculated degree of schedule disruption risk meeting a threshold, performing at least one action from a group consisting of:
      a. raising an alert, and
      b. revising the maintenance process plan.
         This aspect of the disclosed subject matter can further optionally comprise one or more of features (i) to (x) listed above with respect to the system, mutatis mutandis, in any desired combination or permutation which is technically possible.

According to another aspect of the presently disclosed subject matter there is provided a computer program product comprising a computer readable non-transitory storage medium containing program instructions, which program instructions when read by a first processing circuitry, cause the processing circuitry to perform a method of assessing a degree of risk of schedule disruption in executing a automated maintenance process plan in an industrial facility, the automated maintenance process plan comprising a plurality of sequences of maintenance tasks, the method comprising:
i) receiving, from one or more monitoring units (MUs), data indicative of progress of a maintenance task of a first maintenance task sequence of the plurality of sequences of maintenance tasks, and
ii) determining, in accordance with the received task progress data, data indicative of an updated scheduled start time of a subsequent maintenance task of the first maintenance task sequence, thereby giving rise to an updated total float value (TFV) of the first maintenance task sequence;
the storage medium further containing program instructions which program instructions when read by a second processing circuitry, cause the second processing circuitry to perform a method of assessing a degree of risk of schedule disruption in executing a automated maintenance process plan in an industrial facility, the automated maintenance process plan comprising a plurality of sequences of maintenance tasks, the method comprising
i) obtaining and storing data indicative of an updated TFV of the first maintenance task sequence, thereby giving rise to an updated TFV history of the first maintenance task sequence,
ii) calculating, for the first maintenance task sequence, a degree of schedule disruption risk, in accordance with, at least, the updated TFV history of the first maintenance task sequence, and
iii) responsive to, at least, the calculated degree of schedule disruption risk meeting a threshold, performing at least one action from a group consisting of:
   a. raising an alert, and
   b. revising the maintenance process plan.
      This aspect of the disclosed subject matter can further optionally comprise one or more of features (i) to (x) listed above with respect to the system, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an example deployment of an industrial facility with control systems for performing maintenance processes on an industrial system, in accordance with some embodiments of the presently disclosed subject matter;

FIG. 2 illustrates a logical structure of an example maintenance process plan, in accordance with some embodiments of the presently disclosed subject matter;

FIG. 3 illustrates an example deployment an example block diagram of an example monitoring and alerting system, in accordance with some embodiments of the presently disclosed subject matter;

FIG. 4A illustrates an example scheduled task sequence of a maintenance process plan, according to some embodiments of the presently disclosed subject matter;

FIG. 4B illustrates which illustrates an example of runtime changes to scheduling in a task sequence, in accordance with some embodiments of the presently disclosed subject matter;

FIG. 4C illustrates an example of runtime changes to scheduling of a task sequence, in which realtime delays in execution of individual maintenance tasks result in a schedule disruption, in accordance with some embodiments of the presently disclosed subject matter;

FIG. 5 illustrates an example deployment of an industrial facility with control systems for performing maintenance processes on an industrial system, in accordance with some embodiments of the presently disclosed subject matter; and

FIG. 6 illustrates a flow diagram of an example method of calculating a degree of risk of schedule disruption of a task sequence, in accordance with some embodiments of the presently disclosed subject matter;

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “monitoring”, “controlling”, “determining”, “calculating”, “receiving”, “providing”, “obtaining”, “updating”, “alerting”, “revising”, “removing”, “initiating”, “storing”, “classifying” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

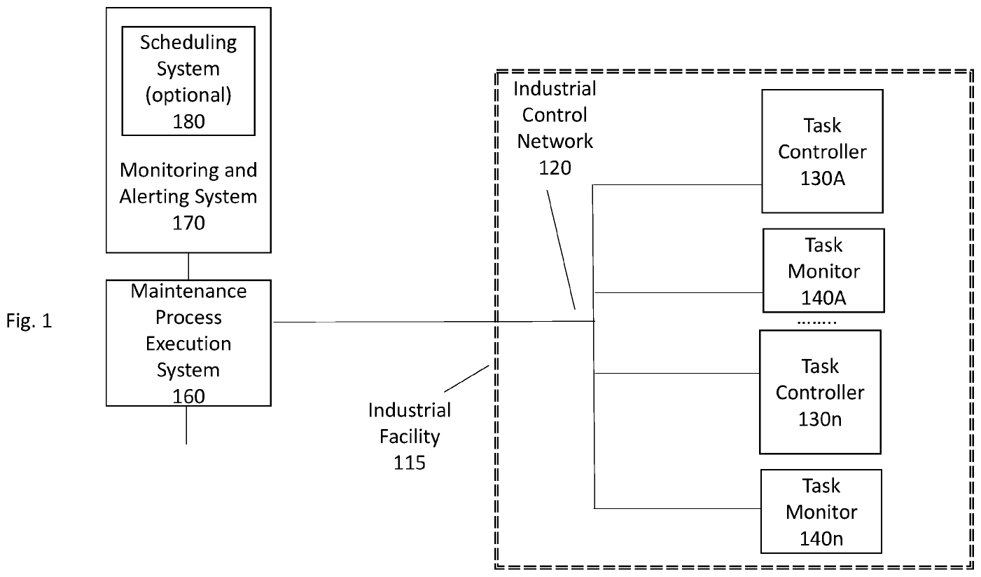

Attention is now directed to FIG. 1, which illustrates an example deployment of an industrial facility with control systems for performing maintenance processes on an industrial system, in accordance with some embodiments of the presently disclosed subject matter.

Industrial facility 115 can be an industrial facility that implements a certain industrial process. For example: industrial facility 115 can be a power generation facility utilizing gas turbines.

Industrial facility 115 can include an industrial control network 120 that is operably connected to various task controllers 130A 130n and task monitors 140A 140n.

Task controllers 130A 130n can be devices which carry out particular maintenance, inspection, or similar functions. By way of non-limiting example: a task controller 130A 130n can be a device to center a rotor in a bearing, or to apply line oil to a flange sealing surface, or a stationary or moving camera that performs inspection of a turbine component. In some examples, task controllers 130A 130n are devices that necessitate involvement/action by human personnel.

Task monitors 140A 140n can be devices which collect data on the progress and/or current status of maintenance functions. In some examples, task monitors 140A 140n are sensors that are integrated into task controllers 130A 130n. In some examples, task monitors 140A 140n are standalone devices. In some examples, task monitors 140A 140n are cameras which receive images of specific equipment and utilize computer vision or image analysis techniques to determine the status of an in-progress maintenance task based on the received image. In some examples, task monitors 140A 140n are devices that receive status input by human personnel.

Industrial control network 120 can be any kind of suitable data communication mechanism e.g. ethernet or cellular.

Maintenance process execution system 160 can be operably connected to industrial control network 120 and can—for example—send commands to task controllers 130A 130n and receive status information from task monitors 140A 140n (for example: via industrial control network 120). Maintenance process execution system 160 can be a computer including a processing circuitry, which in turns includes a processor, memory, and communications unit.

Maintenance process execution system 160 can initiate and control a maintenance process (for example: a complex maintenance process involving multiple tasks operating in parallel, where some tasks are dependent on the completion of other tasks).

To perform the complex task of controlling an automated physical maintenance process, maintenance process execution system 160 can utilize a maintenance process plan.

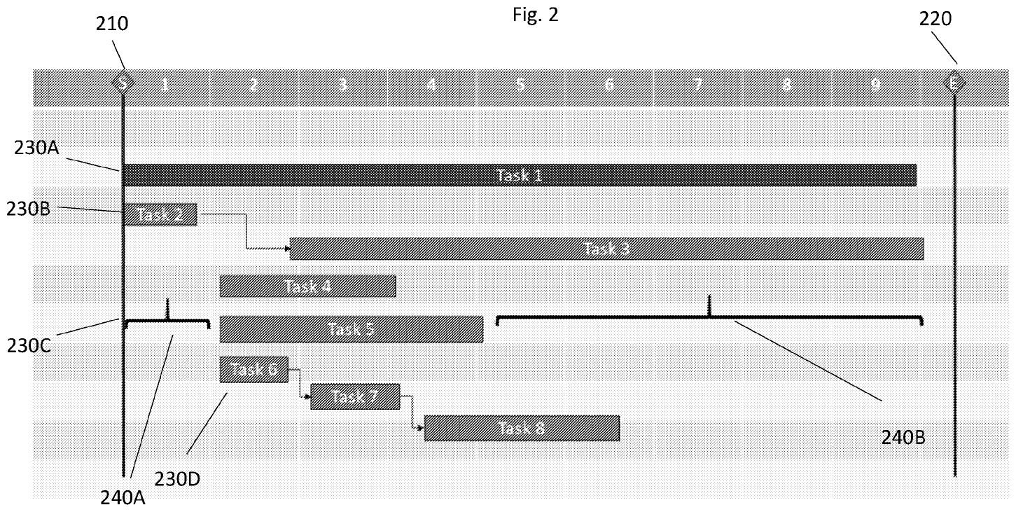

An example logical structure of a maintenance process plan is described in detail below, with reference to FIG. 2.

Generally, a maintenance process plan can consist of a plurality of task sequences. Each task sequence, in turn, can consist of a series of maintenance tasks to be executed sequentially (i.e. each task typically completes before the next one begins). A given task sequence is generally a series of maintenance actions applied to a single piece of equipment or related pieces of equipment. The maintenance process plan can include—for each task—a scheduled start time and a duration, as well as other parameters.

When initiating and controlling a maintenance process, maintenance process execution system 160 can utilize—for example—a networked control application to initiate a particular task, and then to monitor the progress of the task. Once the task is complete, maintenance process execution system 160 can wait for the scheduled start time of the next task in the task sequence (if necessary), and can then initiate the next task.

In some examples, if completion of a task is delayed (e.g. if a component self-test repeatedly failed, so that the component needed to be replaced), then maintenance process execution system 160 delays the initiation of the subsequent task. In this manner, completion of subsequent tasks in a task sequence (and thus of the entire maintenance process) can become delayed. To avoid completion delay, a maintenance process plan (whether prepared automatically or by a human) can include “float” (as described in more detail below with reference to FIG. 2). In real-time, delays in execution of tasks of the task sequence reduces the amount of float for the particular task sequence in the maintenance process plan.

An example of a maintenance process execution system 160 is described in U.S. Pat. No. 8,090,462 (“Maintenance Assistance and Control System method and Apparatus”).

Monitoring and alerting system 170 can be operably connected to maintenance process execution system 160 (for example via a wired or wireless communication link). Monitoring and alerting system 170 can receive maintenance process plan data from maintenance process execution system 160. The received data can pertain to tasks and task sequences e.g. scheduled task start times and task durations, as well as details of the tasks themselves (components involved etc.).

Monitoring and alerting system 170 can receive, from maintenance process execution system 160, ongoing updates pertaining to task progress. Specifically: monitoring and alerting system 170 can receive updates indicative of the total float value for a particular task sequence—for example: updates that result from task progress (and delays therein) as determined by maintenance process execution system 160.

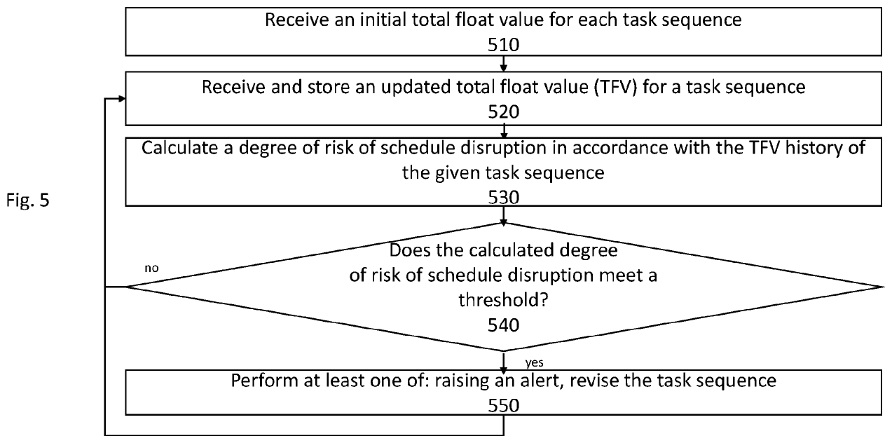

Monitoring and alerting system 170 can utilize the total float values (as recorded over time) to assess the risk of schedule disruption of the maintenance process plan, as well as to assess the time of the maintenance process completion. An example method of assess the risk of schedule disruption using the historical float information is described below, with reference to FIG. 5.

Monitoring and alerting system 170 can raise an alert, or take corrective action in response to its assessment of the risk of schedule disruption, as detailed below.

Monitoring and alerting system 170 (for example) can include optional scheduling system 180. Scheduling system 180 can create or revise a maintenance process plan—for example: in response to an assessment of risk of schedule disruption that meets a threshold. In some embodiments, scheduling system 180 can supply a revised maintenance process plan to maintenance process execution system 160 for immediate or subsequent execution. In some embodiments, scheduling system 180 is physically separate from monitoring and alerting system 170 and can be operably connected to monitoring and alerting system 170 and maintenance process execution system 160.

It is noted that the teachings of the presently disclosed subject matter are not bound by the system described with reference to FIG. 1. Equivalent and/or modified functionality can be consolidated or divided in another manner and can be implemented in any appropriate combination of software with firmware and/or hardware and executed on a suitable device. The maintenance process execution system 160, monitoring and alerting system 170, and scheduling system 180 can each be standalone entities, or integrated, fully or partly, with other entities.

Attention is now directed to FIG. 2, which illustrates an example logical structure of a maintenance process plan, in accordance with some embodiments of the presently disclosed subject matter.

The maintenance process plan can specify a start time 210 and an end time 220 for the maintenance process. In FIG. 2, time units are denoted by numerals along the top horizontal axis.

The maintenance process plan can consist of a plurality of task sequences 230A 230B 230C 230D. In some embodiments, each task sequence is a parallelizable sequence of tasks, where each task in the sequence is dependent on the completion of the task before it. Thus: task sequence 230A consists of Task 1, task sequence 230B consists of tasks 2 and 3 etc.

Task sequences in the maintenance process plan can include time intervals 240A 240B wherein no task is executed. Such time intervals can be termed “float”. The presence of “float” in the task sequences in the maintenance process plan enables delays to take place without causing a delay in the planned completion time of the maintenance process. The “total float” for a task sequence can be the total of float values between the tasks in the task sequence. For example, the initial value of the total float for task sequence 230C can be the duration of float 240A added to the duration of float 240B.

It is noted that a maintenance process plan can include additional levels of hierarchy e.g., tasks can be composed of a series of sequentially executed subtasks etc.

It is noted that a deployed maintenance process plan can include hundreds of thousands of task sequences (or more), and that a task sequence can includes hundreds or thousands of tasks (or more).

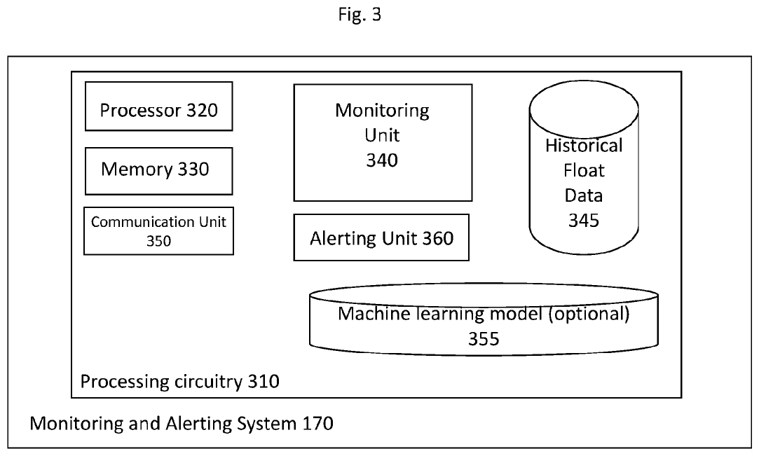

Attention is now directed to FIG. 3, which illustrates an example block diagram of an example monitoring and alerting system, in accordance with some embodiments of the presently disclosed subject matter.

Monitoring and alerting system 300 can include a processing circuitry 310. Processing circuitry 310 can include a processor 320 and a memory 330.

Processor 320 can be a suitable hardware-based electronic device with data processing capabilities, such as, for example, a general purpose processor, digital signal processor (DSP), a specialized Application Specific Integrated Circuit (ASIC), one or more cores in a multicore processor etc. Processor 320 can also consist, for example, of multiple processors, multiple ASICs, virtual processors, combinations thereof etc.

Memory 330 can be, for example, a suitable kind of volatile and/or non-volatile storage, and can include, for example, a single physical memory component or a plurality of physical memory components. Memory 330 can also include virtual memory. Memory 330 can be configured to, for example, store various data used in computation.

Processing circuitry 310 can be configured to execute several functional modules in accordance with computer-readable instructions implemented on a non-transitory computer-readable storage medium. Such functional modules are referred to hereinafter as comprised in the processing circuitry. These modules can include, for example, monitoring unit 340, communication unit 350, and alerting unit 360.

Communication unit 350 can be any kind of suitable data communication mechanism allowing exchange of data with other system components—for example: ethernet, cellular etc.

Monitoring unit 340 can receive data pertaining to the current state of execution of a maintenance process, and can then store the data to (for example) historical float data database 345. By way of non-limiting example, monitoring unit 340 can receive data from maintenance process execution system 160 via communication unit 350.

More specifically: in some embodiments, monitoring unit 340 can receive data indicative of an updated total float value (TFV) for a particular sequence of maintenance tasks. The TFV can be a time quantity which denotes the maximum amount of time that the currently executing task of the task sequence can be delayed without causing follow-on delays that result in a later completion of the full maintenance process plan. Monitoring unit 340 can store data indicative of the updated TFV value (for example: to historical float data database 345)

The periodic storing of updated TFVs results in a series of historical TFVs (for example: in historical float data database 345) for each maintenance task sequence.

Monitoring unit 340 can then utilize this series to evaluate schedule disruption risk i.e. the risk that completion time of the maintenance task sequence will be delayed past the scheduled end of the maintenance process plan. By way of non-limiting example: if the TFV of a maintenance task sequence has been steadily dropping (e.g. the rate of decline of the TFV meets some threshold), monitoring unit 340 can then raise an alert to a human operator, transmit an indication to maintenance process execution system 160, or take a different preventative or corrective action.

By way of further non-limiting example, monitoring unit 340 can include a machine-learning based classification engine that has been trained to classify TFV series so as to identify series that are indicative of subsequent schedule delay.

Alerting unit 360 can perform actual alerting e.g. providing a visual or audible signal to a human operator, signaling an indication to maintenance process execution system 160 etc.

It is noted that the teachings of the presently disclosed subject matter are not bound by the system described with reference to FIG. 3. Equivalent and/or modified functionality can be consolidated or divided in another manner and can be implemented in any appropriate combination of software with firmware and/or hardware and executed on a suitable device. The monitoring and alerting system 300 can be a standalone entity, or integrated, fully or partly, with other entities.

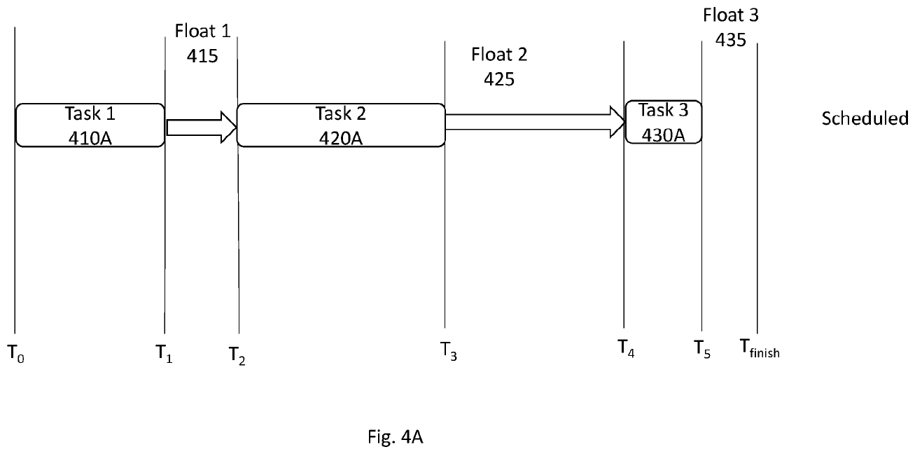

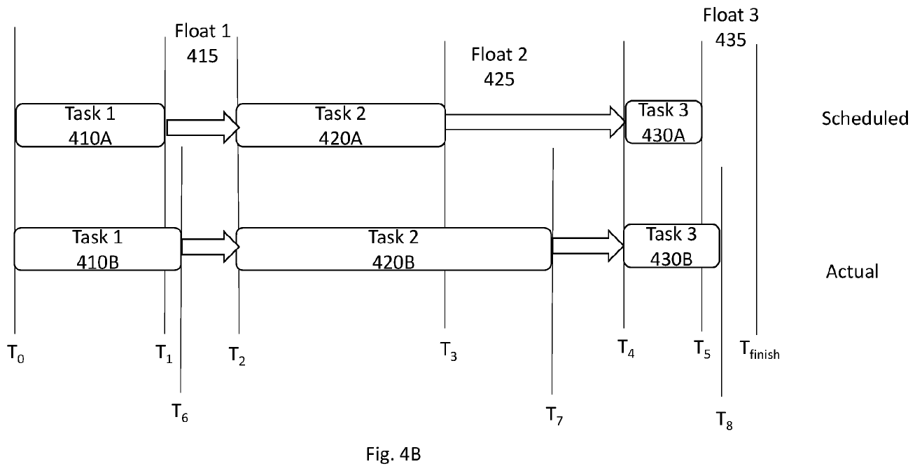

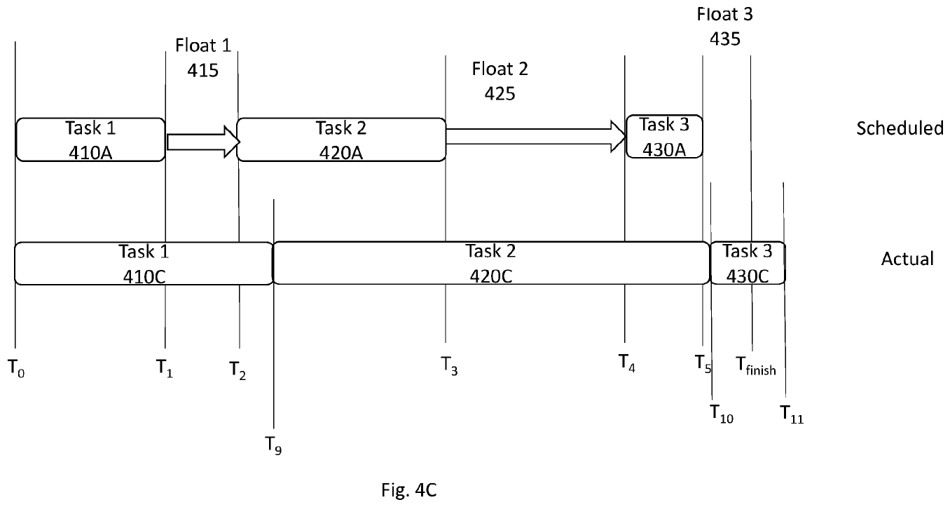

Attention is now directed to FIG. 4A, which illustrates an example scheduled task sequence of a maintenance process plan, according to some embodiments of the presently disclosed subject matter.

Task 1 410A can be a particular remotely-initiated maintenance task (e.g. a cleaning cycle) on a particular item of equipment. Task 1 410A is scheduled to be initiated (e.g. by maintenance process execution system 160) at time Tₒ, and is scheduled to have duration of (T₁−Tₒ).

The scheduled task sequence of the maintenance process plan includes Float 1 415 following the completion of Task 1 410A. Float 1 415 is scheduled to begin at time T₁ (with completion of Task 1), and continue until time T₂.

Similarly: Task 2 420A is scheduled in the maintenance process plan to begin at T₂ and have duration (T₃−T₂). Float 2 425 is scheduled to begin at T₃ and continue until T₄. Task 3 430A is scheduled in the maintenance process plan to begin at T₄ and have duration (T₅−T₄). Float 3 435 is scheduled to begin at T₅ etc.

T_{finish} can denote the time at which all task sequences in the maintenance process plan are scheduled to complete. If a task sequence completes later than T_{finish}, a schedule disruption has occurred.

The TFV for the task sequence (as scheduled) is the sum of Float 1 415, Float 2 425, Float 3 435 i.e. (T₂−T₁)+(T₄−T₃)+(T_{Finish}−T₅).

Attention is now directed to FIG. 4B, which illustrates an example of runtime changes to scheduling in the task sequence of FIG. 4A, which can occur in response to realtime delays in execution of individual maintenance tasks of the maintenance process plan, according to some embodiments of the presently disclosed subject matter.

In the example of FIG. 4B, Task 1 410B begins at T₀ as scheduled, but completion of Task 1 410B is delayed from T₁ to T₆ (e.g. due to a mechanical failure necessitating replacement of a part). Because the schedule of the task sequence in the maintenance process plan includes Float 1 415, the delayed completion of Task 1 410B does not impact the initiation of Task 2 420B (e.g. maintenance process execution system 160 can initiate Task 2 410B at its scheduled time). At time T₆, the TFV for the task sequence is (T₂−T₆)+(T₄−T₃)+(T_{Finish}−T₅). It is noted this TFV is the same TFV that indicated by the schedule for time T₆.

Similarly, completion of Task 2 420B is delayed from T₃ to T₇, and the presence of Float 2 415 in the schedule prevents the delay from resulting in schedule disruption, and Task 3 430B can be initiated (for example: by maintenance process execution system 160) at the scheduled time T₄. At time T₇, the TFV for the task sequence is (T₄−T₇)+(T_{Finish}−T₅). It is noted this TFV is the same TFV that is indicated by the schedule for time T₇. Task 3 430B then experiences a delay and completes at T₈. Since T₈ is within float 3 435 and before T_{finish}, no schedule disruption has occurred.

Attention is now directed to FIG. 4C, which illustrates an example of runtime changes to scheduling of the task sequence of FIG. 4A, in which realtime delays in execution of individual maintenance tasks result in a schedule disruption, according to some embodiments of the presently disclosed subject matter.

In the example of FIG. 4C, completion of Task 1 410C is delayed from T₁ to T₉. Because the delay in completion of Task 1 410C extends past Float 1 415, the delay impacts the initiation of Task 2 420C (e.g. maintenance process execution system cannot initiate Task 2 420C at its scheduled time T₂ but rather at T₉). Accordingly, at time T₉, the TFV for the task sequence can be calculated as ((T₄−T₃)−(T₉−T₂))+(T_{Finish}−T₅). It is noted that this value is less than the TFV indicated by the schedule for time T₉ i.e. the late initiation of task 2 causes TFV to decrease more than scheduled.

Due to its late initiation and its own completion delay, Task 2 420C completes at T₁₀, and Task 3 430C completes at T₁₁. T₁₁ is after T_{finish}, so schedule disruption has occurred, and completion of the entire maintenance project plan has been delayed.

It is noted than in real-world scenarios, task sequences can consist of 10s or 100s of tasks, and schedule disruptions can result in maintenance project plan completion delays of 50% or more.

It is noted that a maintenance project plan (whether created by a human or an automated system) should be organized so as to prevent or minimize likelihood of schedule disruption, but that doing so can be challenging.

In some embodiments of the presently disclosed subject matter, monitoring and alerting system 170 periodic monitors the current TFV of a task sequence, and utilizes the resulting TFV history to compute a heuristic degree of risk of schedule disruption, as described in detail hereinbelow.

Attention is now directed to FIG. 5, which illustrates a flow diagram of an example method of assessing risk of schedule disruption in execution of an ongoing industrial maintenance process, in accordance with some embodiments of the presently disclosed subject matter.

In some embodiments, processing circuitry 310 (e.g. monitoring unit 340) can receive (510) data indicative of an initial total float value for at least one task sequence of the plurality of task sequences that are comprised in the maintenance process plan. By way of non-limiting example: processing circuitry 310 (e.g. monitoring unit 340) can receive (510) data indicative of an initial total float value for each of the task sequences. Processing circuitry (e.g. monitoring unit 340) can receive data indicative of initial total float values from, for example, maintenance process execution system 160.

An initial total float value is an initial value usable in the ongoing monitoring of total float for a respective task sequence. In some embodiments, the initial total float value is the total float value indicated in the initial maintenance process plan. If no initial total float value is received for a particular task sequence, then processing circuitry 310 (e.g. monitoring unit 340) can perform its ongoing assessment exclusively on the basis of realtime updates of total float for the task sequence (as described below).

In some embodiments, processing circuitry 310 (e.g. monitoring unit 340) receives data informative of the series of individual float values of the task sequence (see e.g. float 1 415, float 2 425, float 3 435 in FIG. 4A above). In some embodiments, the scheduled individual float values can be subsequently utilized in evaluating schedule disruption risk as detailed below.

Processing circuitry 310 (e.g. monitoring unit 340) can next receive (520) data indicative of an updated total float value of a task sequence of the maintenance process plan. For example, processing circuitry 310 (e.g. monitoring unit 340) can receive the updated total float value from maintenance process execution system 160. In some embodiments, a total float value of a task sequence is received. In some embodiments, a series of between-task float values of a task sequence is received. In some embodiments, other suitable data indicative of the updated total float value of the task sequence is received.

As described hereinabove, maintenance process execution system 160, in some embodiments, calculates data indicative of an updated total float value of a task sequence responsive to e.g. receiving updated task status information from a task monitor 140A 140n.

Processing circuitry 310 (e.g. monitoring unit 340) can next store data indicative of the updated total float value (e.g. to memory 330). In some embodiments, the data is stored in the format in which it was received. In some embodiments, the data is stored in a different format. The series of updated total float values that processing circuitry 310 (e.g. monitoring unit 340) receives (and stores) over a time interval for a particular task sequence is herein termed a TFV history.

Processing circuitry 310 (e.g., monitoring unit 340) can next calculate (530) a degree of risk of schedule disruption in accordance with the TFV history of the task sequence.

The term “degree of risk of schedule disruption” as used herein denotes a heuristic value usable for predicting schedule disruption in subsequent execution of the maintenance process plan.

In some embodiments, processing circuitry 310 (e.g., monitoring unit 340) computes a degree of risk of schedule disruption in accordance with the TFV history by calculating a function e.g.

DegreeOfRisk=F(MetricOfCurrentTFVDecrease)
where:
MetricOfCurrentTFVDecrease denotes a measure of decrease in the TFV of the task sequence that has already occurred during at least part of the current execution of the maintenance process plan, as indicated by the TFV history, and
F( ) is a function that translates the metric to a degree of risk (e.g. to a value suitable for comparison with a threshold). For example: F ( ) can be the identity function.

The metric of current (i.e. already occurred) TFV decrease can be predictive of subsequent schedule disruption, as such a metric is informative of how much of the accommodatable task delay (i.e. float provided by the maintenance process plan) has been utilized and how much additional task delay can still be accommodated. Furthermore, tasks within a task sequence can often pertain to a particular set of equipment or to particular procedures, so that excessive delays in early tasks of a task sequence can be correlated with delays of later tasks of the task sequence.

By way of non-limiting example, processing circuitry 310 (e.g., monitoring unit 340) can compute MetricOfCurrentTFVDecrease in accordance with the formula:

$${Metric}_{0} = {TFV}_{current} - {TFV}_{initial}$$

wherein
TFVᵢₙᵢₜᵢₐₗ is an initial TFV for the task sequence (e.g. the TFV indicated by the schedule of the task sequence of the maintenance process plan, or a received TFV), and
TFV_{current} is a subsequent TFV (e.g. the most recently received TFV).

It is noted that Metric₀ is a basic metric, as it does not account for factors such as the number of task initiation delays which occurred thus far in execution of the maintenance process plan (e.g. three smaller task initiation delays can create the same amount of TFV decline as one long task initiation delay, but may be regarded as a greater indication of risk).

Accordingly, processing circuitry 310 (e.g., monitoring unit 340) can instead—by way of non-limiting example—compute the metric e.g. in accordance with the number and duration of the task initiation delays of the TFV history e.g.

$${Metric}_{1} = {\sum }_{i = 1}^{current} \vert ( T {FV}_{i} - T {FV}_{i - 1} ) - ( SchedT FV - SchedT {FV}_{i - 1} ) \vert \cdot {C}_{i}$$

where TFVᵢ is a received TFV, TFVᵢ₋₁ is a previous received TFV, and SchedTFVᵢ and SchedTFVᵢ₋₁ are the scheduled TFVs at the times corresponding to TFV and TFVᵢ₋₁.

Cᵢ is an embodiment-specific (either hard-coded or realtime-determined) coefficient which multiplies each change in TFV. Thus if Cᵢ increases monotonically, task initiation delays that are later in the task sequence will be regarded as more indicative of risk. By subtracting (SchedTFVi−SchedTFVi), the equation excludes decrease of TFV due to scheduled pauses between tasks (i.e. due to the float as described in FIGS. 4A-4C hereinabove) from the metric.

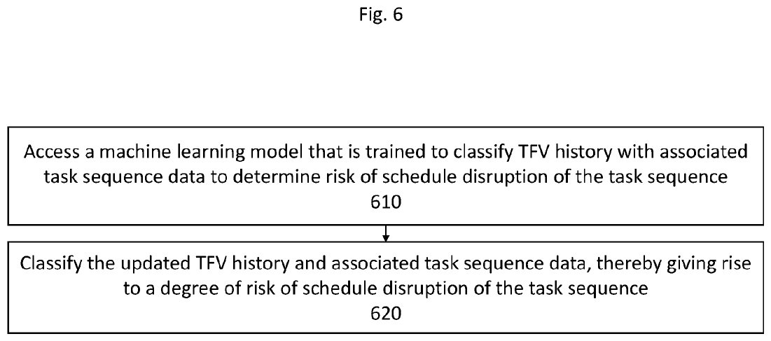

In some other embodiments, processing circuitry 310 (e.g., monitoring unit 340) calculates a degree of risk of schedule disruption in accordance with the TFV history by utilizing a trained machine learning model 355. Processing circuitry 310 (e.g., monitoring unit 340) can supply the TFV history data to a classification function implemented in machine learning model 355, resulting in a classification to a degree of risk (e.g. “high-risk”/“not high risk”). Details of computing a degree of risk of schedule disruption in accordance with the TFV history by utilizing trained machine learning model 355 is described below, with reference to FIG. 6.

The calculated degree of risk of schedule disruption can be a scalar value, a vector of values, a data structure, a group of data structures etc.

Processing circuitry 310 (e.g. monitoring unit 340) can next evaluate whether (540) the calculated degree of risk of schedule disruption meets a threshold.

The threshold that is utilized can be defined in accordance with the specific computation of the degree of risk of schedule disruption.

For example: if the degree of risk is calculated in accordance with a metric of current TFV decrease, processing circuitry 310 (e.g. monitoring unit 340) can use a threshold that is specified (statically or dynamically) in accordance with a baseline TFV decrease. By way of non-limiting example: if the degree of risk is identical with Metric₀ above, then the threshold utilized can be (SchedTFVcurrent−TFVinitial).

Alternatively, if a machine learning model is utilized to classify the series of total float values as e.g. “high-risk”/“not-high-risk”, processing circuitry 310 (e.g. monitoring unit 340) can regard the “high-risk” result as meeting the threshold.

The comparison between the degree of risk and the threshold can be done my comparing scalars, comparing vectors, or more complex comparison methods.

Responsive to, at least, the calculated degree of schedule disruption risk meeting the threshold, processing circuitry 310 (e.g. monitoring unit 340 or scheduling system 180) can perform (550) at least one of:
a) raising an alert e.g. present an audible or visible message to a human operator
b) revising the maintenance process plan

In some embodiments, revising the maintenance process plan includes removing one or more tasks from a task sequence of the maintenance process plan. In some embodiments, revising the maintenance process plan includes reordering one or more tasks of the task sequence of the maintenance process plan in an appropriate manner. By revising the maintenance process plan in accordance with the calculated degree of risk, processing circuitry 310 (e.g. monitoring unit 340 or scheduling system 180) can reduce the risk and/or operational impact of a subsequent schedule disruption.

The raising of an alert and/or revising of the maintenance process can be further responsive to other characteristics of the task sequence, including:
a) criticality of equipment maintained in the task sequence
b) operational importance of the maintenance tasks of the task sequence
c) duration of the task sequence (e.g. it may be more important to prevent disruption of a task sequence of a longer duration)

By way of non-limiting example: processing circuitry 310 (e.g. monitoring unit 340) can utilize differing thresholds for comparison with the calculated degree of risk, in accordance with these other task characteristics.

Processing circuitry 310 (e.g. monitoring unit 340) can next receive and store (520) updated total float values for the task sequence e.g. when these become available.

In some embodiments, processing circuitry 310 (e.g. monitoring unit 340) receives, stores, and assesses—on an ongoing basis—updated total float values for each task sequence of the maintenance process plan.

It is noted that the teachings of the presently disclosed subject matter are not bound by the flow chart illustrated in FIG. 5, the illustrated operations substantially concurrently or can occur out of the illustrated order. For example, operations 510 and 520 shown in succession can be executed substantially concurrently or in the reverse order. It is also noted that whilst the flow chart is described with reference to elements FIGS. 1 and 3, and logical structures of FIGS. 2 and 4A-4C, this is by no means binding, and the operations can be performed by elements other than those described herein.

Attention is now directed to FIG. 6, which illustrates a flow diagram of an example method of calculating a degree of risk of schedule disruption of a task sequence, in accordance with some embodiments of the presently disclosed subject matter.

Processing circuitry 310 (e.g. monitoring unit 340) can access (610) a suitably trained and configured machine learning model 355, The machine learning model 355 be trained—for example—using datasets of TFVs of previously executed task sequences and risk results (e.g. “high-risk” vs. “not-high-risk”, or a multivalue classification result). In some embodiments the machine learning model can be trained using data that is e.g. derivative or indicative of such datasets.

In some embodiments, machine learning model 355 can be trained to utilize additional data associated with a task sequence (e.g. data indicative of particular equipment, particulars of maintenance operations etc.).

Processing circuitry 310 (e.g. monitoring unit 340) can next classify input data that is in accordance with the updated TFV history of the first task sequence, utilizing the machine learning model, thereby giving rise to a degree of risk of schedule disruption of the first task sequence

By way of non-limiting example: the input data can be indicative of at least 2 TFVs of the updated TFV history, consist of the at least 2 TFVs of the updated TFV history itself, or be derivative of data indicative of at least 2 TFVs of the updated TFV history or derivative of at least 2 TFVs of the updated TFV history itself.

In some embodiments, processing circuitry 310 (e.g. monitoring unit 340) can classify (utilizing the machine learning model) input data that is in accordance with the updated TFV history of the first task sequence and is also in accordance with additional data associated with the task sequence. By way of non-limiting example: the input data can include the associated additional data.

It is noted that the teachings of the presently disclosed subject matter are not bound by the flow chart illustrated in FIG. 6. It is also noted that whilst the flow chart is described with reference to elements FIGS. 1 and 3, and logical structures of FIGS. 2 and 4A-4C, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A system of assessing a degree of risk of schedule disruption in executing a automated maintenance process plan in an industrial facility, the automated maintenance process plan comprising a plurality of sequences of maintenance tasks, the system comprising:
a) a first processing circuitry configured to, repeatedly:
i) receive, from one or more monitoring units (MUs), data indicative of progress of a maintenance task of a first maintenance task sequence of the plurality of sequences of maintenance tasks, and
ii) determine, in accordance with the received task progress data, data indicative of an updated scheduled start time of a subsequent maintenance task of the first maintenance task sequence,
thereby giving rise to an updated total float value (TFV) of the first maintenance task sequence; and
b) a second processing circuitry configured to, repeatedly:
i) obtain and store data indicative of an updated TFV of the first maintenance task sequence, thereby giving rise to an updated TFV history of the first maintenance task sequence,
ii) calculate, for the first maintenance task sequence, a degree of schedule disruption risk, in accordance with, at least, the updated TFV history of the first maintenance task sequence, and
iii) responsive to, at least, the calculated degree of schedule disruption risk meeting a threshold, perform at least one action from a group consisting of:
a. raising an alert, and
b. revising the maintenance process plan.

2. The system of claim 1, wherein the second processing circuitry is configured to calculate the degree of schedule disruption risk in accordance with a metric of current TFV decrease.

3. The system of claim 2, wherein the second processing circuitry is configured to calculate the degree of schedule disruption risk in accordance with a difference between an initial TFV and a current TFV.

4. The system of claim 3, wherein the initial TFV is a TFV indicated by the maintenance process plan, and the current TFV is a most recently received TFV.

5. The system of claim 3, wherein the threshold is in accordance with a difference between a scheduled current TFV and the initial TFV, wherein the scheduled current TFV is a TFV indicated by the maintenance project plan for a time corresponding to the current TFV.

6. The system of claim 1, wherein the second processing circuitry is configured to calculate the degree of schedule disruption risk in accordance with a machine learning model classification of data that is in accordance with at least 2 TFVs of the updated TFV history of the first task sequence.

7. The system of claim 6, wherein the second processing circuitry is further configured to calculate the degree of schedule disruption risk in accordance with a machine learning model classification of data that is in accordance with additional data associated with the first task sequence.

8. The system of claim 1, wherein the second processing circuitry is configured to perform the at least one action additionally responsive to, at least, a criticality of equipment maintained in the first maintenance task sequence.

9. The system of claim 1, wherein the second processing circuitry is configured to perform the at least one action additionally responsive to, at least, an operational importance of the maintenance tasks of the first maintenance task sequence.

10. The system of claim 1, wherein the second processing circuitry is configured to perform the at least one action additionally responsive to, at least, a duration of the first maintenance task sequence.

11. The system of claim 1, wherein the first processing circuitry and the second processing circuitry are integrated.

12. A method of assessing a degree of risk of schedule disruption in executing a automated maintenance process plan in an industrial facility, the automated maintenance process plan comprising a plurality of sequences of maintenance tasks, the method comprising:
a) performing, repeatedly, by a first processing circuitry:
i) receiving, from one or more monitoring units (MUs), data indicative of progress of a maintenance task of a first maintenance task sequence of the plurality of sequences of maintenance tasks, and
ii) determining, in accordance with the received task progress data, data indicative of an updated scheduled start time of a subsequent maintenance task of the first maintenance task sequence,
thereby giving rise to an updated total float value (TFV) of the first maintenance task sequence; and
b) performing, repeatedly, by a second processing circuitry:
i) obtaining and storing data indicative of an updated TFV of the first maintenance task sequence, thereby giving rise to an updated TFV history of the first maintenance task sequence,
ii) calculating, for the first maintenance task sequence, a degree of schedule disruption risk, in accordance with, at least, the updated TFV history of the first maintenance task sequence, and
iii) responsive to, at least, the calculated degree of schedule disruption risk meeting a threshold, performing at least one action from a group consisting of:
a. raising an alert, and
b. revising the maintenance process plan.

13. A computer program product comprising a non-transitory computer readable storage medium containing program instructions, which programs instructions when read by a first processing circuitry, and causes the first processing circuitry to perform a method of assessing a degree of risk of schedule disruption in executing a automated maintenance process plan in an industrial facility, the automated maintenance process plan comprising a plurality of sequences of maintenance tasks, the method comprising:
i) receiving, from one or more monitoring units (MUs), data indicative of progress of a maintenance task of a first maintenance task sequence of the plurality of sequences of maintenance tasks, and
ii) determining, in accordance with the received task progress data, data indicative of an updated scheduled start time of a subsequent maintenance task of the first maintenance task sequence,
thereby giving rise to an updated total float value (TFV) of the first maintenance task sequence;
the storage medium further containing program instructions, which programs instructions when read by a second processing circuitry, and causes the second processing circuitry to perform a method of assessing a degree of risk of schedule disruption in executing an automated maintenance process plan in an industrial facility, the method comprising:
i) obtaining and storing data indicative of an updated TFV of the first maintenance task sequence, thereby giving rise to an updated TFV history of the first maintenance task sequence,
ii) calculating, for the first maintenance task sequence, a degree of schedule disruption risk, in accordance with, at least, the updated TFV history of the first maintenance task sequence, and
iii) responsive to, at least, the calculated degree of schedule disruption risk meeting a threshold, performing at least one action from a group consisting of:
a. raising an alert, and
b. revising the maintenance process plan.
